(19) United States
(12) Patent Application Publication
(10) Pub. No.: US 2025/0374869 A1
(43) Pub. Date: Dec. 11, 2025

(54) LIGHTING SYSTEMS AND METHODS OF USE

(71) Applicants: Nicholas Edward Frazier, Lake Station, IN (US); Melody J. Williams, Lake Station, IN (US)

(72) Inventors: Nicholas Edward Frazier, Lake Station, IN (US); Melody J. Williams, Lake Station, IN (US)

(21) Appl. No.: 19/232,505

(22) Filed: Jun. 9, 2025

Related U.S. Application Data
(60) Provisional application No. 63/657,195, filed on Jun. 7, 2024.

(51) Int. Cl. A01G 7/04; A01G 7/02; A01G 9/24; F21V 14/02

(52) U.S. Cl. CPC A01G 7/045; A01G 7/02; A01G 9/247; F21V 14/02

(57) ABSTRACT

Lighting systems and methods of use. Such a lighting system has a carriage that carries an electric light and travels along an arcuate path to simulate the path of the sun over flora and/or fauna. A boom extends along the arcuate path, and the carriage travels along the boom. The carriage has a motor connected to a drive member operable to drive the carriage along the arcuate path. Optionally an adjustable timer may be used to set start and/or stop times for the carriage and/or the speed the carriage as the carriage travels along the arcuate path so that the lighting system can be adjusted to more closely simulate different natural sunlight conditions, such as day length, sunrise and/or sunset times, or even the period of an overall solar day cycle.

### CROSS-REFERENCE TO RELATED APPLICATIONS

This application claims the benefit of U.S. Provisional Application No. 63/657,195 filed Jun. 7, 2024, the contents of which are incorporated herein by reference.

### BACKGROUND OF THE INVENTION

The invention relates generally to a light system and methods of using the light system.

Growing most plants indoors can be difficult because the sunlight that typically provides the energy for photosynthesis is not directly available to the plants. To overcome this, various solutions have been developed, such a hothouse with entire walls made out of glass or translucent materials to allow sunlight to reach the plants. This solution, however, may not be practicable in many circumstances where solid walls are needed. Other solutions include using electric grow lights, which emit a light spectrum more similar to the light spectrum emitted by the sun or a light spectrum tailored to better meet the photosynthesis energy requirements for plants. Some typically used conventional grow lights are high-intensity discharge lights, including high-pressure sodium (HPS) lights and metal halide (MH) lights, as well as some fluorescent lights and LEDs that emit selected light frequencies suitable for stimulating plant growth. Nevertheless, such systems only mimic a small portion of the natural process by which plants receive solar energy, which may deprive the plants of other factors of directly receiving natural sunlight—both understood and not yet understood—that are also important in the growth of plants.

Therefore, it would be desirable to have an indoor lighting system for growing plants that more fully provides the beneficial growth factors of natural sunlight.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, lighting systems for use in indoor growing facilities and methods of using the lighting system to provide growing light to flora and/or fauna disposed indoors.

According to a nonlimiting aspect, a lighting system for use in indoor growing facilities includes a boom extending along an elongate arcuate path, a carriage carried on the boom, and an electric light carried by the carriage. The carriage travels on the boom along the elongate arcuate path to simulate the path of the sun over flora and/or fauna disposed below the track.

According to another nonlimiting aspect, a method of using the lighting system to provide growing light to flora and/or fauna disposed indoors includes moving the carriage on the boom along elongate arcuate path with the electric light turned on to simulate the path of the sun.

Technical aspects of lighting systems and methods as described above preferably include the ability to provide light for growing plants that more fully provides at least some beneficial growth factors of natural sunlight.

These and other aspects, arrangements, features, and/or technical effects will become apparent upon detailed inspection of the figures and the following description.

### BRIEF DESCRIPTION OF THE DRAWINGS

FIG. 1 is a front view of a lighting system of an embodiment of the present invention.

FIG. 2 is an enlarged front view of a light carriage on a boom of the lighting system of FIG. 1.

FIG. 3 represents the light carriage as viewed from sectional line 3-3 in FIG. 2.

FIG. 4 is a front view of a light carriage adapted for use with the lighting system of FIG. 1 according to another embodiment of the present invention.

FIG. 5 is a side view of the light carriage of FIG. 4.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of the embodiment(s) depicted in the drawings. The following detailed description also identifies certain but not all alternatives of the embodiment(s) depicted in the drawings. As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to recite particularly point out subject matter regarded as aspects of the invention, including certain but not necessarily all of the aspects and alternatives described in the detailed description.

To facilitate the description provided below of the embodiment(s) represented in the drawings, relative terms, including but not limited to, “proximal,” “distal,” “anterior,” “posterior,” “vertical,” “horizontal,” “lateral,” “front,” “rear,” “side,” “forward,” “rearward,” “top,” “bottom,” “upper,” “lower,” “above,” “below,” “right,” “left,” etc., may be used in reference to the orientation of the lighting system during its use and/or as represented in the drawings. All such relative terms are useful to describe the illustrated embodiment(s) but should not be otherwise interpreted as limiting the scope of the invention.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

The present application discloses an indoor plant light system that simulates the path of the sun for use in indoor growing facilities. Use of the lighting system for growing plants indoors without access to several hours of direct sunlight can provide the plants with a growing environment that more closely mimics a natural outdoor growing environment relative to duration of exposure to sunlight and/or the change in angle of incidence of the sunlight on the plant across a typical solar day cycle.

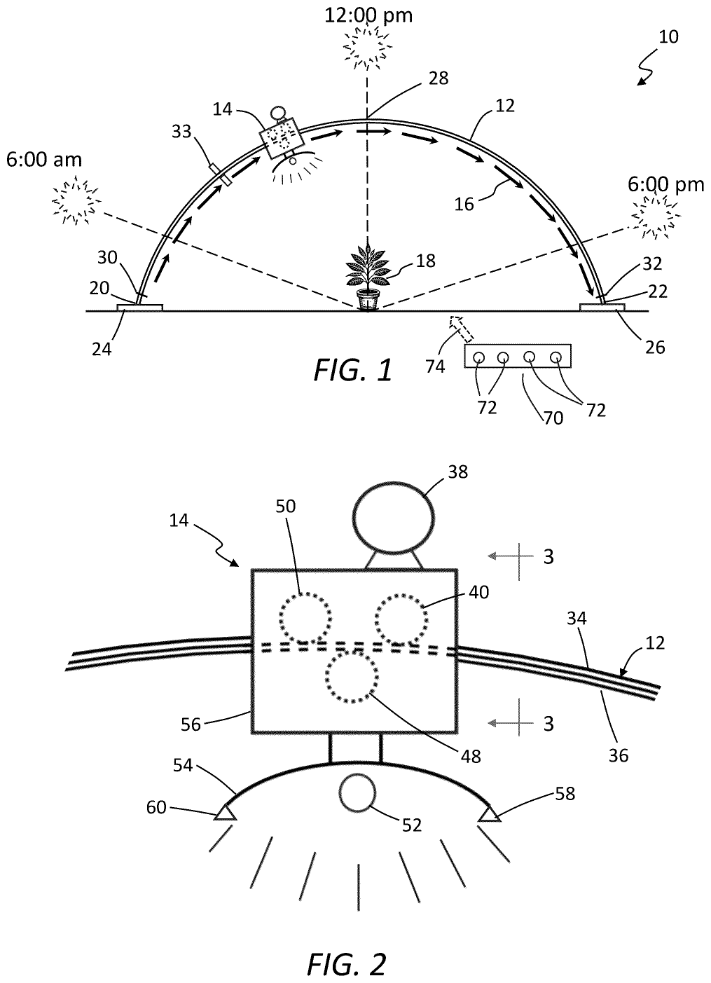

Turning now to the nonlimiting embodiments represented in the drawings, FIGS. 1-3 schematically depict a lighting system 10 according to a first nonlimiting embodiment. The lighting system 10 includes a boom 12 and a light carriage 14 supported by the boom 12. The light carriage 14 travels along an elongate arcuate path 16 to simulate the movement of the sun during a typical day from sunrise in the morning to sunset at night over one or more plants 18 for which growing light is being supplied. The boom 12 is typically disposed directly above any plant (or plants) 18 so that the light carriage 14 will travel the arcuate path 16 over the plant(s) over a predefined time period.

The arcuate path 16 is generally defined by the boom 12. Preferably, the boom 12 defines the arcuate path 16 as approximately semicircular or parabolic and extending over an angle of about 90° to about 180°, the latter of which enables two locations at opposite ends of the path 16 to simulate the Earth's horizon at or adjacent opposite ends of the boom 12. In this example, the boom 12 extends from a first end 20 of the boom 12 supported and anchored by a first support 24 to a second end 22 of the boom 12 supported and anchored by a second support 26, such that the boom 12 has a vertical zenith 28 at the top of the arcuate path 16 that is approximately mid-way above and between the first and second ends 20 and 22.

A first stop 30 is located at or near the first end 20 of the boom 12 and a second stop 32 is located at or near the second end 22 of the boom 12. The stops 30 and 32 are located so as to stop the light carriage 14 from traveling past the stops 30 and 32 and off the respective first and second ends 20 and 22 of the boom 12. The stops 30 and 32 may be configured, for example, to engage a switch carried by the light carriage 14 that turns a drive mechanism of the light carriage 14 off when the light carriage 14 engages the stop 30 or 32. The boom 12 is also shown as equipped with a removable stop 33 that can be attached to the boom 12 so that the carriage 14 can be supported on the boom 12 with the stop 33 during repair, service, etc., of the boom 12 and/or carriage 14, and later removed from the boom 12 to permit travel of the carriage 14 between the stops 30 and 32.

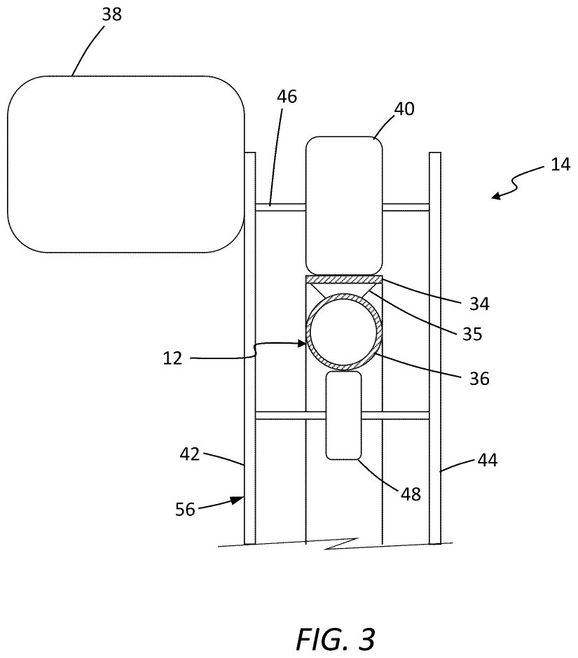

As best seen in FIGS. 2 and 3, the illustrated the boom 12 comprises a track 34 supported by a support beam 36. The track 34 has a generally flat upper surface in the width direction and a generally arcuate shape in the length direction that generally defines and/or follows the arcuate path 16. The support beam 36 is represented in FIG. 3 as defined by an elongate hollow tube member, such as a hollow circular or rectangular tube. However, the support beam 36 may have other shapes or forms. A plurality of struts 35 spaced apart from each other along the length of the boom 12 couple the track 34 to the support beam 26 so that the track 34 runs along the top side of the support beam 36 along the entire length of the boom 12 from the first end 20 to the second end 22, or at least long enough to allow the light carriage 14 to travel completely from one stop 30 to the other stop 32 along the track 34. The boom 12 may be formed of several individual arcuate segments that are connected end to end to form the entire length of the boom 12 from its first end 20 to its second end 22. In one example, the boom 12 is formed of three separate arcuate segments connected together end to end with a total height of about 8 feet (about 2.4 m) and a total cord length from the first end 20 to the second end 22 of about 24 feet (about 7.3 m); however, the boom 12 may be constructed of fewer segments (e.g., one or two) or more than three segments and have different heights and cord lengths.

The light carriage 14 is represented in FIGS. 2 and 3 as including at least one drive mechanism carried by a frame 56 and configured to drive the entire light carriage 14 along the track 34 between the stops 30 and 32. In this example, the drive mechanism includes an electric motor 38 operatively coupled to a drive member that moves the light carriage 14 in at least one and preferably both directions along the track 34. In this example, the drive member is in the form of a drive wheel 40 that contacts and rolls along the top surface of the track 34 when rotated by the motor 38. However, the drive member may have other forms, such as a gear drive (e.g., rack and pinion), an infinite track, a screw drive, or any other drive mechanism suitable for moving the light carriage 14 forward and/or backward along the arcuate path 16. The frame 56 in this example is formed by a pair of side panels 42 and 44 that are spaced apart in a width direction to form a space therebetween in which the width of the boom 12 fits. The motor 38 is shown as mounted to the side panel 42 and a drive axle 46 of the drive wheel 40 is operatively coupled with the motor 38 to rotate the drive wheel 40 for moving the light carriage 14 along the track 34. The side panels 42 and 44 are connected by one or more cross members, such as the drive axle 46 or any other suitable cross members. The motor 38 is preferably a variable-speed electric motor that can be adjusted and/or controlled to vary the velocity of the light carriage 14 along the arcuate path 16.

FIGS. 2 and 3 further represent the carriage 14 as comprising a retaining member 48 that is spaced apart from and below the drive wheel 40 to engage the bottom surface of the boom 12, which in this example is the bottom surface of the support beam 36, in order to retain the light carriage 14 on the boom 12 with the drive wheel 40 operatively engaged against the track 34. This retaining member 48, also referred herein as the lower retaining member 48, is configured to move along the bottom surface of the support beam 36, for example, by sliding or rolling. A second retaining member 50 may be provided that is spaced apart from the drive wheel 40 and disposed to engage the top surface of the boom 12, for example the track 34, to further help retain the light carriage 14 operatively engaged with the boom 12. This retaining member 50, also referred herein as the upper retaining member 50, is configured to move along the top surface of the track 34, for example, by sliding or rolling. In this example, each of the retaining members 48 and 50 comprises a wheel that rolls along the respective bottom and top sides of the boom 12 and mounted between the side panels 42 and 44 on respective axles. In this arrangement, the axles also serve as cross members to hold the side panels 42 and 44 together to form the frame 56. However in other embodiments, either or both of the retaining members 48 and 50 may have other forms, for example simply slide along the surface(s) of the boom 12. As best seen in FIG. 2, the drive wheel 40 and the two retaining members 48 and 50 are arranged in a generally triangular array with the lower retaining member 48 on the inner/lower radius/surface of the boom 12 being disposed between (in a lengthwise direction along the length of the boom 12) the upper retaining member 50 and the drive wheel 40 disposed on the upper/outer radius/surface of the boom 12, which assists with retaining the light carriage 14 in an operative configuration on the boom 12 with the drive wheel 40 engaged against the track 34 along the entire length of the arcuate path 16. This configuration also rotates the frame 56 (e.g., side panels 42 and 44) as the light carriage 14 moves along the arcuate path 16 to always have its interior side directed generally toward the approximate radial center of the arcuate path 16 and/or where the plant 18 is located.

As shown in FIGS. 1 and 2, an electric light 52 is carried by the light carriage 14 and configured to shine toward the plant 18 located under the boom 12 at all points along the arcuate path 16. The light 52 is preferably an electric grow light, such as a high-intensity discharge light. For example, the light 52 may include a high-pressure sodium light and preferably emits at least 140,000 lumens. In one configuration, the light 52 is a 10,000 Watt high pressure sodium lamp; however other types and strengths of grow lights could be used. The light 52 is part of a lamp assembly that includes a reflector 54 adapted to direct to reflect light from the electric light 52 generally toward an area at or near the (approximately) radial center of the arcuate path 16, for example, where the plant(s) 18 are located. The reflector 54 may additionally be configured to have thermal insulating properties and/or inhibit thermal radiation from its top surface to minimize heating of the carriage 14 by the light 52. The lamp assembly preferably is attached rigidly to the frame 56 of the light carriage 14 so that the reflector 54 and the light 52 are always directed generally toward the approximate radial center area of the arcuate path 16 along substantially the entire length of the pathway 16 between the stops 30 and 32. In this way, the light emitted from the lamp assembly will always be directed toward the plant(s) 18 along the entire pathway 16 and the angle of incidence of the emitted light against the plant 18 will change from one side to the opposite side as the light carriage 14 moves along the track 34. This provides light conditions for the plant(s) 18 that more closely simulate the motion of the sun and change in incidence angle of sunlight for plants outside.

The motor 38 may be controlled by a control unit 70 equipped with one or more digital and/or analog adjustable timers 72 that are adjustable by a user to control activation times and speeds of the motor 38. Communication 74 between the control unit 70 and carriage 14 can be wireless or via electrical wiring. As a nonlimiting example, two of the adjustable timers 72 can be used to control, respectively, the activation time and the speed of the motor 38 as the motor 38 travels from the first end 20 to the second end 22 of the boom 12, and a second pair of timers 72 can be used to control, respectively, the activation time and the speed of the motor 38 as the motor 38 travels in an opposite direction, i.e., from the second end 22 to the first end 20 of the boom 12. In the embodiment shown, in which the boom 12 defines an approximately semicircular or parabolic arcuate path 16 extending over an angle of about 180° so as to correspond to the Earth's horizon, the control unit 70 is preferably capable of controlling the timing and speed of the carriage 14 as it travels between the stops 30 and 32 to simulate natural sunlight conditions. For example, the time and speed conditions may be set so that the light carriage 14 will turn the light 52 on and start moving from the stop 30 at 6:00 a.m. at an angle of a few degrees (e.g.) 10-20°) above the horizon, arrive at the zenith 28 at 12:00 noon, and finally arrive at the stop 32 at 6:00 p.m. at an angle of a few degrees (e.g., 10-20°) above the horizon where the light 52 and the drive motor 38 are turned off. However, the speed and/or time could be adjusted by a user to start and/or stop the light carriage 14 and light 52 and/or control the speed of travel of the light carriage 14 to take more or less time to traverse the arcuate path 16 from one stop 30 or 32 to the other stop 32 or 30. In this way, the movement of the light 52 can be controlled to more closely simulate the actual duration of sunlight and angular movement of the sun in an open outdoor growing setting, and/or the lighting system may be adjusted to more closely simulate different natural sunlight conditions, such as day length, sunrise and/or sunset times, or even the period of an overall solar day cycle

In some optional configurations, the lighting system 10 may also include other features useful for growing the plant(s) 18. For example, FIG. 2 represents the lighting system 10 as including a carbon dioxide fumer 58 that is configured to direct a flow of carbon dioxide toward the plant(s) 18 under the boom 12 to encourage faster growth of the plants. The carbon dioxide fumer 58 may be operatively coupled to source of carbon dioxide and include one or more nozzles configured to direct the carbon monoxide toward the plants. For example, one or more nozzles of the carbon dioxide fumer 58 may be carried by the light carriage 14 and oriented to direct carbon monoxide under the arcuate path 16 toward any plants under the boom 12. Other locations for the nozzles could also be used, such as supported by and/or along the boom 12 itself.

In another optional configuration, FIG. 2 represents the lighting system 10 as including a water feed 60 that directs a flow (e.g., stream, mist, shower, etc.) of water toward the plant(s) 18 under the boom 12. The water feed 60 may be operatively coupled to a source of water, including a mixture of water and fertilizer, and include one or more nozzles configured to direct the water and/or mixture toward the plants, for example as a spray or mist. For example, one or more nozzles of the water feed 60 may be carried by the light carriage 14 and oriented to direct water under the arcuate path 16 toward any plants under the boom 12. Other locations for the nozzles could also be used, such as supported by and/or along the boom 12 itself.

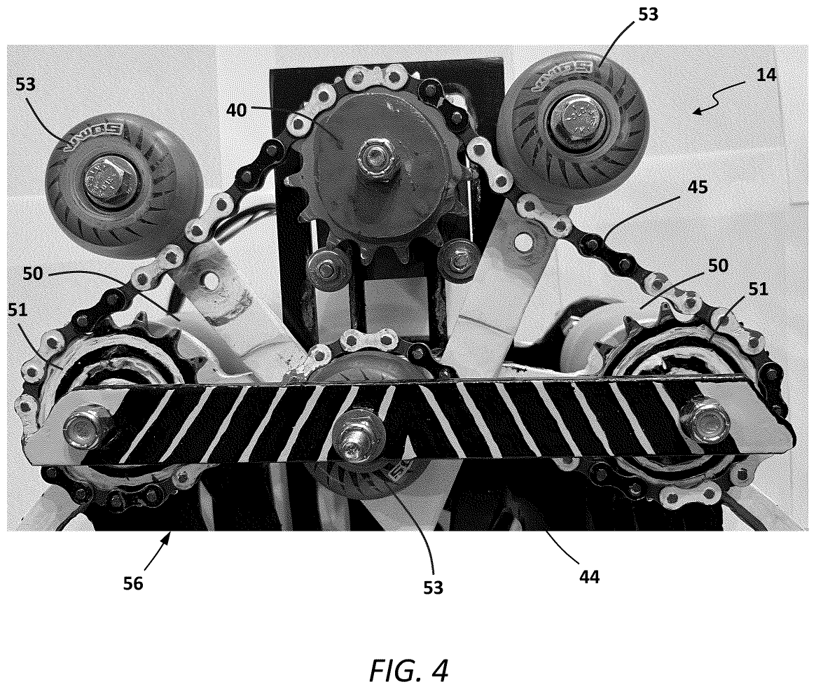

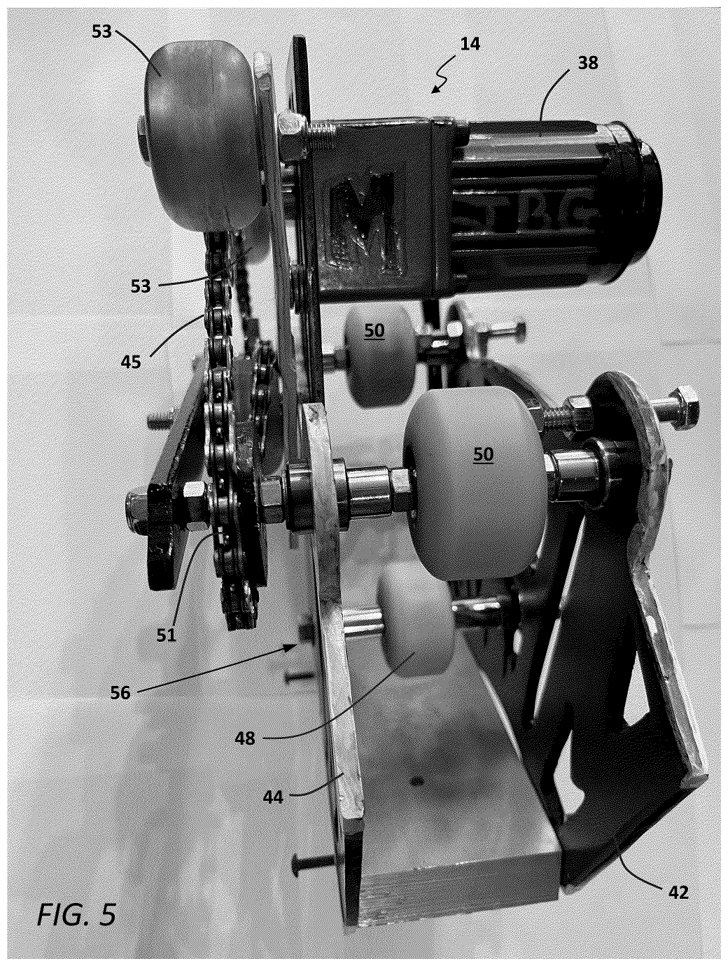

FIGS. 4 and 5 represent another embodiment of the carriage 14 of the lighting system 10. In view of similarities between the embodiments, the following discussion of FIGS. 4 and 4 will focus primarily on aspects of the second embodiment that differ from the first embodiment in some notable or significant manner. Other aspects of the second embodiment not discussed in any detail can be, in terms of structure, function, materials, etc., essentially as was described for the first embodiment.

FIGS. 4 and 5 represent the carriage 14 as comprising the lower and upper retaining members 48 and 50 similar to those shown for the first embodiment, so that the upper retaining members 50 are vertically located above the lower retaining member 48 on the frame 56. Instead of a single drive wheel connected to the motor 30 and contacting the top surface of the boom 12, the upper retaining members 50 are both adapted as drive wheels as a result of both retaining members 50 being coupled via a chain 45 to a drive member (gear) 40 driven by the motor 38, which is mounted to the side panel 44. As illustrated in FIGS. 4 and 5, each retaining member 50 is coupled to a gear 51 that is driven by the chain 45, which in turn is driven by the drive member 40 and motor 38. An idler wheel 53 is provided between expanses of the chain 45 between the drive member 40 and retaining members 50 to maintain tension in the chain 45. With this configuration, the two driven retaining members 50 are better able to maintain traction on the track 34 of the boom 12, regardless of whether the carriage 14 is ascending or descending the arcuate path 16.

While the lighting system 10 is described as being used primarily for growing plants (flora), it may also be useful in situations with animals (fauna) that are maintained indoors without access to direct natural sunlight. As nonlimiting examples, the lighting system may be used for indoor livestock feeding operations and/or indoor egg laying poultry operations to provide a more natural light setting for the animals.

In addition to providing growing light that can more closely simulate natural sunlight, the lighting system 10 may also save energy and/or lower costs for indoor growing. For example, some typical indoor grow lighting configurations use multiple electric lights disposed at different angles relative to the plants being grown in order to provide growing light to multiple sides of the plants. In contrast, the lighting system 10 can provide light to all (or at least multiple) sides of the plants using as little as a single electric light 52, thereby reducing the amount of electricity needed for the grow lighting. Thus, the lighting system 10 may also provide environmental benefits by reducing the overall energy usage for growing plants indoors.

As previously noted above, though the foregoing detailed description describes certain aspects of one or more particular embodiments of the invention, alternatives could be adopted by one skilled in the art. For example, the lighting system 10 and its components could differ in appearance and construction from the embodiments described herein and shown in the drawings, functions of certain components of the lighting system 10 could be performed by components of different construction but capable of a similar (though not necessarily equivalent) function, and various materials could be used in the fabrication of the lighting system 10 and/or its components. As such, and again as was previously noted, it should be understood that the invention is not necessarily limited to any particular embodiment described herein or illustrated in the drawings.

1. A lighting system for use in indoor growing facilities, the lighting system comprising:
a boom extending along an arcuate path;
a carriage carried on the boom; and
an electric light carried by the carriage,
wherein the carriage travels on the boom along the arcuate path to simulate the path of the sun over flora and/or fauna disposed below the boom.

2. The lighting system of claim 1, wherein the boom comprises an arcuate track supported by a support beam.

3. The lighting system of claim 2, wherein the support beam comprises a tube and the track extends along a top side of the tube, the boom further comprising one or more struts coupling the track to the top side of the tube.

4. The lighting system of claim 1, wherein the arcuate path is an approximately semicircular or parabolic arcuate path that extends over an angle of about 180° so as to correspond to the Earth's horizon.

5. The lighting system of claim 1, wherein the carriage comprises:
a drive member; and
a motor that drives the drive member to cause the carriage to travel along the arcuate path.

6. The lighting system of claim 5, wherein the drive member comprises a drive wheel that engages the boom.

7. The lighting system of claim 5, wherein the carriage further comprises first and second retaining members that are spaced apart so that the boom is between and contacted by the first and second retaining member, the drive member is disposed on and contacts a top surface of the boom, and the first retaining member is disposed below and contacts a lower surface of the boom.

8. The lighting system of claim 7, wherein the carriage further comprises a second retaining member engaging the top surface of the boom.

9. The lighting system of claim 5, wherein the carriage further comprises a lower retaining member and first and second upper retaining members, the lower retaining member is disposed below and contacts a lower surface of the boom, the first and second upper retaining members are disposed on and contact a top surface of the boom, and the drive member is coupled to the first and second upper retaining members with a chain so that the motor rotates each of the first and second upper retaining members with the drive member through the chain to cause the carriage to travel along the arcuate path.

10. The lighting system of claim 1, further comprising:
a first stop at a first end of the boom that stops the carriage from traveling off the first end; and
a second stop at a second end of the boom that stops the carriage from traveling off the second end.

11. The lighting system of claim 10, further comprising a control unit having at least first and second adjustable timers that are adjustable by a user to control activation times and speeds of the motor, the first adjustable timer controlling the activation time and the speed of the motor as the motor travels from the first end to the second end of the boom, and, the second adjustable timer controlling the activation time and the speed of the motor as the motor travels from the second end to the first end of the boom.

12. The lighting system of claim 1, wherein the boom comprises a plurality of arcuate segments coupled together to define the arcuate path.

13. The lighting system of claim 1, wherein the motor is an adjustable speed motor that is operable to vary a velocity of the carriage travelling along the boom.

14. The lighting system of claim 1, further comprising a carbon dioxide fumer for directing a flow of carbon monoxide toward an area under the arcuate path.

15. The lighting system of claim 1, further comprising a water feed for directing a flow of water toward an area under the arcuate path.

16. The lighting system of claim 1, wherein the electric light comprises a grow light.

17. The lighting system of claim 1, wherein the electric light comprises a high pressure sodium grow light.

18. The lighting system of claim 1, wherein the electric light emits at least 140,000 lumens.

19. A method of using the lighting system of claim 1 to provide growing light to flora and/or fauna disposed indoors, the method comprising moving the carriage on the boom along the arcuate path with the electric light turned on to simulate the path of the sun.

20. The method of claim 19, further comprising controlling the movement of the carriage so that the movement of the light simulates movement of the sun over the flora and/or fauna between about 6:00 am and about 6:00 pm.
